(19) United States
(12) Patent Application Publication
(10) Pub. No.: US 2026/0233968 A1
(43) Pub. Date: Aug. 13, 2026

(54) ELEVATOR EMERGENCY PHONE AND METHOD FOR CATEGORIZING EMERGENCY CALL TO CALL CENTER FOR ELEVATOR SYSTEMS

(71) Applicant: KONE Corporation, Helsinki (FI)

(72) Inventor: Tommi Huotari, Helsinki (FI)

(73) Assignee: KONE Corporation, Helsinki (FI)

(21) Appl. No.: 19/639,791

(22) Filed: Apr. 6, 2026

Related U.S. Application Data
(63) Continuation of application No. PCT/EP2023/081002, filed on Nov. 7, 2023.

(51) Int. Cl. B66B 3/00; B66B 1/34; B66B 5/02

(52) U.S. Cl. CPC B66B 3/00; B66B 1/3461; B66B 5/02

(57) ABSTRACT

An elevator emergency phone (10) configured for connecting to a call center (1100) is disclosed. The elevator emergency phone (10) comprises a user interface element (12) for initiating an emergency call to the call center (1100), at least one sensor (16) arranged to monitor a condition of elevator car (20) and to generate a sensor signal indicative of the condition. The elevator emergency phone (10) is configured to determine (410), based on the sensor signal, the condition at an initiation of or during the emergency call, and categorize (420) the emergency call, based on the condition, into one of at least two categories.

### FIELD OF THE INVENTION

The present invention relates in general to elevator systems. In particular, however not exclusively, the present invention concerns emergency phones designed to be used in elevator systems.

### BACKGROUND

Elevators must typically be equipped with an alarm or emergency phone. The phones are important so that entrapped passengers, for instance, can quickly get help.

The phones also need to be able to test themselves on a daily basis, for example, by making a simulated test alarm to a call center. The call center phone numbers for the emergency and test calls are programmed to the emergency phone during the installation and commissioning process. These numbers are pointing to call centers, one or more, in the country where the elevator is installed to.

Furthermore, in some cases, the emergency phone must also be able to cancel (so called discrimination feature) emergency calls in case the elevator works correctly. This is to avoid unnecessary calls to the call center to save its capacity for real emergency calls. Also, the unnecessary alarm discrimination requires interfacing to elevator electrification or installing extra sensor to the elevator to detect its running capabilities and ability to open the doors when at landing.

Programming the needed parameters to the emergency phone can be cumbersome due to many reasons and this leads, in the worst case, to a situation that the new elevator installation hand-over to the customer is delayed since the emergency phone needs to be tested by the authorities prior the inspection is approved. There is thus a need to develop and improve elevator emergency phones in view of the drawbacks in the known attempts.

### SUMMARY

An objective of the present invention is to provide an elevator emergency phone and a method for connecting to a call center. Another objective of the present invention is that the elevator emergency phone and the method facilitate the commissioning or installation of the elevator systems with respect to the elevator emergency phone and the functionalities thereof.

The objectives of the invention are reached by an elevator emergency phone and a method for connecting to a call center as defined by the respective independent claims.

According to a first aspect, an elevator emergency phone configured for connecting to a call center is provided. The elevator emergency phone comprises a user interface element, such as a call button or at least a switch, sensor or the like arranged in connection with a call button, for initiating an emergency call to the call center and at least one sensor arranged to monitor a condition of elevator car and to generate a sensor signal indicative of the condition.

The elevator emergency phone is configured to determine, based on the sensor signal, the condition at an initiation of or during the emergency call, and to categorize the emergency call, based on the condition, into one of at least two categories.

Preferably, the at least two categories may include critical calls and non-critical calls. Categorization of a call into the critical calls category may include determining, based on the determined condition of elevator car, that there is a fault or malfunction related to the operation of the elevator car, for example, however, not limiting to, the elevator car being stuck in the elevator shaft and/or the elevator door(s) not opening or closing in a normal manner. Other situations not mentioned herein may also lead to categorization of a call into the critical calls category. On the other hand, categorization of a call into the non-critical calls category may include determining, based on the determined condition of elevator car, that the elevator is operating in a normal manner in that there are no special conditions related to the operation of the elevator car. These may relate to accidental or unintentional calls, or mischievous calls.

In various embodiments, the elevator emergency phone may be configured to prevent or stop the emergency call in case it is categorized into the non-critical calls category.

In some preferable embodiments, the at least one sensor may comprise a movement sensor for detecting movement of the elevator car. Optionally, the movement sensor may be a speed sensor or an acceleration sensor.

In some preferable embodiments, the at least one sensor may, alternatively or in addition, comprise a door sensor for determining a door condition of the elevator car. Optionally, the door sensor may be a vibration sensor for measuring vibrations due to a movement of a door of the elevator car. Alternatively or in addition, the door sensor may be a magnetic sensor or a magnetic switch for measuring and/or detecting a change in a magnetic field caused by at least one magnet positioned to a door or a door mechanism of the elevator car, the at least one magnet being arranged to move with the door or the door mechanism. Still alternatively or in addition, the door sensor may be an optical sensor, such as a camera, directed towards a door of the elevator car. As understood, the at least one sensor may comprise a plurality of sensors with different sensor types.

The elevator emergency phone may further be configured to determine a location of the elevator emergency phone. Furthermore, the location may be determined automatically at a start-up of the elevator emergency phone. Optionally, the determination of the location is performed based on a network identification information of a network in which the elevator emergency phone is set to operate or currently operating. Alternatively or in addition, the elevator emergency phone may comprise a location sensor, wherein the determination of the location is performed based on data from the location sensor. The location sensor may be operable with a satellite-based position system, such as being a GPS (Global Positioning System) sensor.

When a communication unit of the elevator emergency phone connectivity means (including, for example, 2G, 3G, 4G device or the like) gets connected to a mobile phone network, the used mobile phone network identity code (MCC ID) is given to the unit, and hence the unit and the phone knows to which country and network it is connected to. The identity code, MCC ID, is unique for each country and network.

In some embodiments, to make the elevator emergency phone more accurate, rather than using the MCC ID code only, the GPS positioning can be used together with the MCC ID code. Thus, the location of the phone may be determined based on a network identification information and a location sensor. The location sensor may be included in the elevator emergency phone or in another device, such as in user's mobile phone. Furthermore, the network identification information may also be obtained via a communication unit of the elevator emergency phone or from the user's mobile phone, for instance.

For example, when an elevator system is sold, installed, taken to maintenance, or just visited, the visitor, such as the user or a maintenance person, may easily check the exact location of the elevator with his/her mobile phone and then store the location to an enterprise resource planning (ERP) system or other such system storing elevator information which includes all information of the elevator being stored thereinto.

One important piece of information of an elevator is its equipment number, such as an elevator identifier, for example, including a unique string of numbers and/or letters, for identifying the elevator. The elevator identifier may be assigned to the elevator during the installation or the commissioning, for instance.

When the elevator GPS position and the elevator identifier are stored to an ERP with an elevator address, these pieces of information can be utilized in the elevator emergency phone to get the correct location each time whereas using only the MCC ID code could provide a failure when operating near a country border and, thus, wrong country settings may be taken into use.

The elevator emergency phone may be configured to send its GPS position on its start-up to the cloud server or the like remote service, and then that GPS position may be used in finding proper settings for that installation location from the ERP. The ERP would then trigger downloading of the correct parameters (the equipment number, phone numbers etc.) to the elevator emergency phone via the cloud server.

In addition, the elevator emergency phone may be configured to include emergency call center contact details, and select one of the emergency call center contact details to be used for the emergency call based on the determined location. Said one of the emergency call center contact details may, preferable, be selected automatically at a start-up of the elevator emergency phone. Thus, the number for the (most convenient) call center is selected automatically for emergency calls without a need to (re-)configure the phone when it's being initiated/started.

The emergency call center contact details are, preferably, pre-stored in a memory device of the elevator emergency phone.

Furthermore, the elevator emergency phone comprises a base material, such as a printed circuit board or the other electronic substrate, and a controlling unit, wherein the at least one sensor and the controlling unit are arranged on the base material and connected to each other via a conductor on the base material.

According to a second aspect, a method is provided. The method is preferably for categorizing an emergency call to a call center for elevator systems. The method comprises determining, based on a sensor signal of at least one sensor arranged to monitor a condition of elevator car and to generate the sensor signal indicative of the condition, the condition at an initiation of or during an emergency call, and categorizing the emergency call, based on the condition, into one of at least two categories.

Preferably, the at least two categories include critical calls and non-critical calls which were already discussed hereinbefore with respect to the first aspect.

Furthermore, the method may comprise preventing or stopping the emergency call in case it is categorized into the non-critical calls category.

According to a further aspect, an elevator system is provided which comprises an elevator emergency phone in accordance with the first aspect or any of the embodiments thereof, and an elevator car comprising such an elevator emergency phone.

The present invention provides an elevator emergency phone, an elevator system, and a method for categorizing an emergency call to a call center for elevator systems. The present invention provides advantages over known solutions in that faster installation and more automatic commissioning right after power-up of the phone is achieved without need for any remote or local parameter setting.

Various other advantages will become clear to a skilled person based on the following detailed description.

The expression “a number of” may herein refer to any positive integer starting from one (1).

The expression “a plurality of” may refer to any positive integer starting from two (2), respectively.

The terms “first”, “second”, etc. are herein used to distinguish one element from another element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an elevator car comprising an elevator emergency phone.

FIG. 2 illustrates schematically an elevator emergency phone.

FIG. 3 illustrates schematically an elevator system.

FIG. 4 shows a flow diagram of a method for categorizing an emergency call to a call center for elevator systems.

### DETAILED DESCRIPTION OF SOME EMBODIMENTS

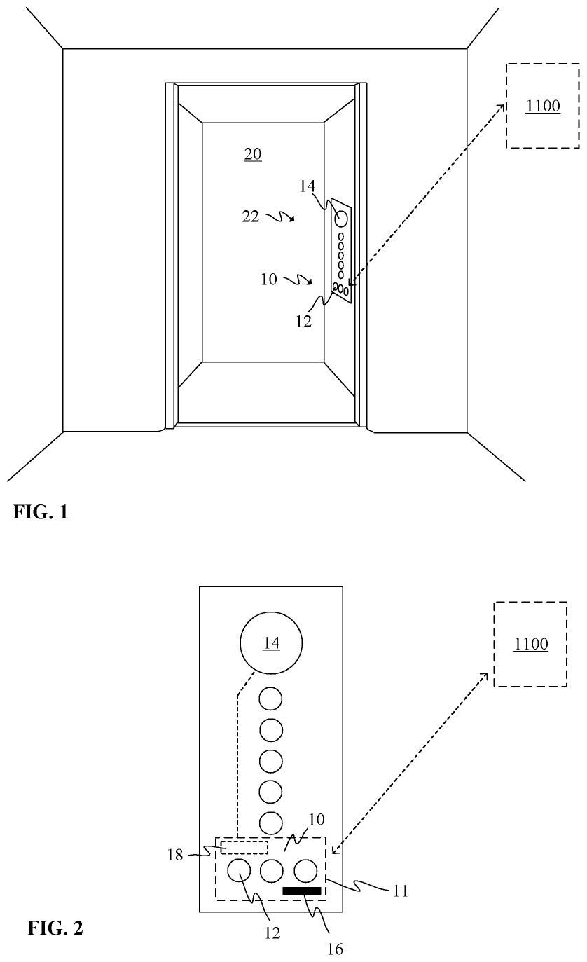

FIG. 1 illustrates schematically an elevator car 20 comprising an elevator emergency phone 10 configured for connecting to a call center 1100. The call center 1100 is typically not part of the elevator system but rather located remotely with respect to the elevator system. The call center 1100 may be a general call center for receiving phone calls or a special call center for receiving emergency calls from elevator systems. The elevator emergency phone 10 may be configured to be connected to the call center via a telephone network, such as including wired and/or wireless network (portions).

The elevator emergency phone 10, preferably, comprises a communication unit enabling the basic functions related to making calls, as is known and understandable to a skilled person in the art.

The elevator emergency phone 10 comprises a user interface element 12 for initiating an emergency call to the call center. The user interface element 12 may be a button on the elevator car operating panel 22. Alternatively, the user interface element 12 may be a switch device on a circuit board or the like of the elevator emergency phone 10 which is arranged to be operated by, for example, a button on the elevator car operating panel 22.

In various embodiments, thus, the elevator emergency phone 10 may be arranged mainly behind the elevator car operating panel 22. Only visible elements, if any, may be the user interface element 12, a speaker device 14 and/or a microphone (not shown).

The elevator emergency phone 10 also comprises at least one sensor (not shown in FIG. 1) arranged to monitor a condition of elevator car and to generate a sensor signal indicative of the condition.

For example, the at least one sensor may include a movement sensor for detecting movement of the elevator car. Furthermore, the movement sensor may be a speed sensor or an acceleration sensor. Alternatively or in addition to the movement sensor, the at least one sensor may comprise a door sensor for determining a door condition of the elevator car 20.

In some preferable embodiments, the at least one sensor may comprise a movement sensor for detecting movement of the elevator car. Optionally, the movement sensor may be a speed sensor or an acceleration sensor.

In some preferable embodiments, the at least one sensor may, alternatively or in addition, comprise a door sensor for determining a door condition of the elevator car. Optionally, the door sensor may be a vibration sensor for measuring vibrations due to a movement of a door of the elevator car. Alternatively or in addition, the door sensor may be a magnetic sensor or a magnetic switch for measuring and/or detecting a change in a magnetic field caused by at least one magnet positioned to a door or a door mechanism of the elevator car, the at least one magnet being arranged to move with the door or the door mechanism. Still alternatively or in addition, the door sensor may be an optical sensor, such as a camera, directed towards a door of the elevator car. As understood, the at least one sensor may comprise a plurality of sensors with different sensor types.

In various embodiments, the sensor signal may be compared to threshold values and/or pre-defined and stored acceptable characteristics related to the condition. For example, if the movement sensor detects expected movement with respect to operation of the elevator motion control system, it is concluded that the elevator car condition is acceptable in this sense. On the other hand, if the door sensor detects expected acceptable door operation in response to the command for opening or closing of the elevator car doors, it may be concluded that the door condition and thus even the condition of elevator car is acceptable. As understandable to a skilled person in the art, concluding that the condition of elevator car is acceptable may indeed require acceptable conditions with respect to both, the movement of the elevator car and the door operation.

The elevator emergency phone may further be configured to determine a location of the elevator emergency phone. Furthermore, the location may be determined automatically at a start-up of the elevator emergency phone. Optionally, the determination of the location is performed based on a network identification information of a network in which the elevator emergency phone is set to operate or currently operating. Alternatively or in addition, the elevator emergency phone may comprise a location sensor, wherein the determination of the location is performed based on data from the location sensor. The location sensor may be operable with a satellite-based position system, such as being a GPS (Global Positioning System) sensor.

When a communication unit of the elevator emergency phone connectivity means (including, for example, 2G, 3G, 4G device or the like) gets connected to a mobile phone network, the used mobile phone network identity code (MCC ID) is given to the unit, and hence the unit and the phone knows to which country and network it is connected to. The identity code, MCC ID, is unique for each country and network.

In some embodiments, to make the elevator emergency phone more accurate, rather than using the MCC ID code only, the GPS positioning can be used together with the MCC ID code. Thus, the location of the phone may be determined based on a network identification information and a location sensor. The location sensor may be included in the elevator emergency phone or in another device, such as in user's mobile phone. Furthermore, the network identification information may also be obtained via a communication unit of the elevator emergency phone or from the user's mobile phone, for instance.

For example, when an elevator system is sold, installed, taken to maintenance, or just visited, the visitor, such as the user or a maintenance person, may easily check the exact location of the elevator with his/her mobile phone and then store the location to an enterprise resource planning (ERP) system or other such system storing elevator information which includes all information of the elevator being stored thereinto.

One important piece of information of an elevator is its equipment number, such as an elevator identifier, for example, including a unique string of numbers and/or letters, for identifying the elevator. The elevator identifier may be assigned to the elevator during the installation or the commissioning, for instance.

When the elevator GPS position and the elevator identifier are stored to an ERP with an elevator address, these pieces of information can be utilized in the elevator emergency phone to get the correct location each time whereas using only the MCC ID code could provide a failure when operating near a country border and, thus, wrong country settings may be taken into use.

The elevator emergency phone may be configured to send its GPS position on its start-up to the cloud server or the like remote service, and then that GPS position may be used in finding proper settings for that installation location from the ERP. The ERP would then trigger downloading of the correct parameters (the equipment number, phone numbers etc.) to the elevator emergency phone via the cloud server.

The elevator emergency phone 10 is configured to determine, based on the sensor signal, the condition at an initiation of or during the emergency call, and to categorize the emergency call, based on the condition, into one of at least two categories. Preferably, the at least two categories include critical calls and non-critical calls.

The elevator emergency phone 10 may be configured to prevent or stop the emergency call in case it is categorized into the non-critical calls category. Thus, in case of non-critical calls, the capacity of the call center can be protected or preserved for more critical calls. Examples of non-critical calls may be accidental or unintentional calls, or mischievous calls.

The elevator emergency phone 10 may be configured to determine a location of the elevator emergency phone. The location may be determined automatically at a start-up of the elevator emergency phone 10. The start-up may be initiated when the elevator emergency phone 10 is turned on, that is, being powered. This may happen as planned or after a reboot or a power outage, such as related to a main electrical power supply of the elevator system. Thus, there is no need for a maintenance person to (re)configure the elevator emergency phone 10 after it has been installed and/or after reboot or power outage. The elevator emergency phone 10 can automatically configure itself based on its location.

The determination of the location may be performed based on a network identification information of a network in which the elevator emergency phone is set to operate or currently operating. The network identification information may be obtained based on a mobile country code (MCC) received/obtained by the phone 10 from the network in which it operates in.

Alternatively or in addition to the determination of the location as described above, the elevator emergency phone 10 may comprise a location sensor, wherein the determination of the location may be performed based on data from the location sensor. The location sensor may be operable with a satellite-based position system, such as being a GPS (Global Positioning System) sensor.

The elevator emergency phone 10 may be configured to include emergency call center contact details. For example, there may be one or more than one phone numbers for call centers, such as in different regions or countries, pre-stored into a memory device of the elevator emergency phone 10.

Optionally, the elevator emergency phone 10 may be configured to select one of the emergency call center contact details to be used for the emergency call based on the determined location.

Furthermore, said one of the emergency call center contact details may be configured to be selected automatically at a start-up of the elevator emergency phone 10.

The elevator emergency phone 10 may be further configured to select one or several others of the emergency call center contact details as (a) back-up emergency call center contact detail(s). Furthermore, the elevator emergency phone 10 may be configured to use one of the back-up emergency call center contact details if the

Furthermore, in various embodiments, the elevator emergency phone 10 may further comprise a controlling unit, wherein the at least one sensor and the controlling unit are connected to each other.

The controlling unit may comprise at least a processor and a memory device. The controlling unit may also comprise the communication unit or it may be a separate relative to the controlling unit.

The elevator emergency phone 10 may further either comprise or be connected to a speaker device 14 and/or a microphone (not shown). Thus, the speaker device 14 and/or the microphone may be integrated into the phone 10, such as on a base material thereof, or there may be inputs for connecting these to the phone 10. For example, the elevator emergency phone 10 may use a speaker device 14 and/or a microphone of the elevator car operating panel 22 which is/are connected to input(s) of the phone 10. An example of such a connection is shown in FIG. 2 between the speaker device 14 and the phone 10.

Preferably, the elevator emergency phone 10 may be such that it can be installed essentially as a single device so that once powered on, all of the main functionalities are in use, including at least determining, based on the sensor signal, the condition at an initiation of or during the emergency call, and categorizing the emergency call, based on the condition, into one of at least two categories.

FIG. 2 illustrates schematically an elevator emergency phone 10. FIG. 2 shows, in addition to what is shown in FIG. 1 related to the phone 10, optional a base material 11 of the phone 10. The base material 11 may be or comprise, for example, a printed circuit board or other such substrate for accommodating electronics. FIG. 2 illustrates one example of the sensor 16, that is, being arranged on the base material 11. The sensor 16 could, however, be arranged to the phone 10 in other position than in or on the base material 11, such as to a separate sensor device of the phone 10. Furthermore, the controlling unit 18 is also shown in FIG. 2, as a non-limiting example, being arranged on the base material 11.

Thus, in some embodiments, the base material 11 may comprise, such as on the surface thereof, the controlling unit 18, wherein the at least one sensor 16 and the controlling unit 18 are arranged within or on the surface of the base material 11 and connected to each other via a conductor in or on the base material 11.

The elevator emergency phone 10 may also comprise a housing (not shown), such as of plastic material. The housing may enclose the at least one sensor 16 and the controlling unit 18, as well as the base material 11, if any.

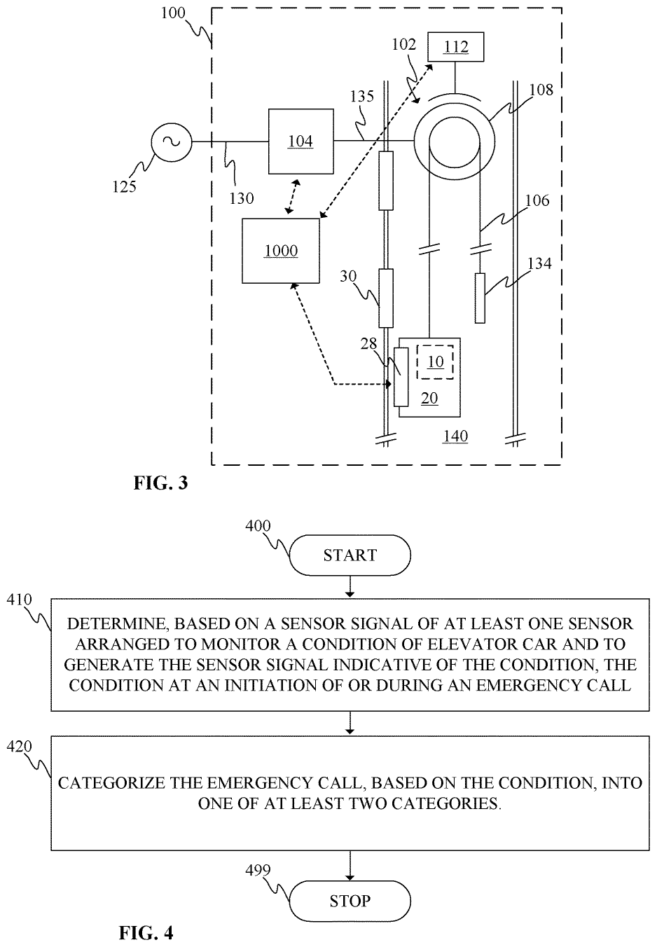

FIG. 3 illustrates schematically an elevator system 100 which may comprise an elevator emergency phone 10 as described hereinabove. The elevator system 100 may comprise an elevator motion control system 104, such as including an electric converter. The elevator system 100 may comprise an elevator, or “hoisting”, motor 102, such as a permanent magnet electric motor, for moving an elevator car 20 comprised in the elevator system 100. The elevator motor 102 may be arranged to rotate a traction sheave 108. The elevator car 20 may be mechanically coupled to the electric motor 102, preferably, by a hoisting rope 106, for example, extending via the traction sheave 108. The operation of the electric motor 102 may be controlled by the elevator motion control system 104, such as including a frequency converter or an inverter. The elevator car 20 may be moved in and/or along an elevator shaft 140. The elevator car 20 may be moved in a normal operation mode to serve landings or landing floors in accordance with elevator calls. Also shown are the elevator car doors 28 and the landing floor doors 30. The sensor(s) 16 of the phone 10 may be arranged especially to monitor the condition of elevator car doors 28.

The hoisting rope 106 may comprise, for example, steel or carbon fibers. The term ‘hoisting rope’ does not limit the form of the rope anyhow. For example, the hoisting rope 106 may be implemented as a rope or a belt.

The elevator motor 102 may be arranged in mechanical coupling with a traction sheave 108. Furthermore, the elevator rope 104 may be arranged to run via the traction sheave 108 for the elevator motor 102 to be able to move the elevator car 20 coupled to the hoisting rope 102. Still further, being connected to the hoisting rope 102, may preferably be a counterweight 114 for the elevator car 20. Although shown in FIG. 3 that the hoisting rope 106 would be attached from one end to the elevator car 20 and from the opposite end to the counterweight 114, and then simply running via the traction sheave 108, in practice, the hoisting rope 106 may run via one or several other sheaves and components, and may be terminated at the hoisting rope terminals, as known to a skilled person in the art. Thus, depending how the hoisting rope 106 is arranged to run, for example, past how many sheaves and how such configuration is designed and arranged, the roping ratio may be different from one elevator system 100 to another.

The elevator system 100 may comprise an elevator control unit 1000 for controlling the operation of the elevator system 100, such as various devices thereof. The elevator control unit 1000 may be a separate device or may be comprised in the other components of the elevator system 100 such as in or as a part of the elevator motion control system 104. In various embodiments, the elevator control unit 1000 comprises the elevator motion control system 104.

In some embodiments, the elevator control unit 1000 may comprise the elevator motion control system 104, however, in other embodiments, they may be separate entities, in which case the elevator control unit 1000 may be in communication connection with the elevator motion control system 104, such as providing input signal/data thereto and/or therefrom.

The elevator control unit 1000 may also be implemented in a distributed manner so that, e.g., one portion of the elevator control unit 1000 may be comprised in the elevator motion control system 104 and another portion in the elevator car 20, for instance. The elevator control unit 1000 may also be arranged in distributed manner at more than two locations or in more than two devices. The elevator control unit 1000 may be arranged to at least communicate (examples of such connections being shown with dashed two-headed arrows) with various devices of the elevator system 100.

The elevator system 100 may further comprise an elevator brake arrangement 112 comprising an elevator brake, preferably, an electromechanical elevator brake.

There may be also a main electrical power supply 125 such as a three-phase or single-phase electrical power grid, an electrical connection 130 between the power supply 125 and the elevator motion control system 104, another electrical connection 135 between the elevator motion control system 104 and the electric motor 102.

FIG. 4 shows a flow diagram of a method for categorizing an emergency call to a call center for elevator systems 100.

Item or step 400 refers to a start-up phase of the method. Suitable equipment and components are obtained, and systems assembled and configured for operation.

The method steps may, in accordance with a non-limiting example, be performed by the elevator emergency phone 10, for example, by the at least one sensor 16 and the controlling unit 18 thereof.

As described hereinabove, the at least two categories may include critical calls and non-critical calls.

Item or step 410 refers to determining, based on a sensor signal of at least one sensor 16 arranged to monitor a condition of elevator car 20 and to generate the sensor signal indicative of the condition, the condition at an initiation of or during an emergency call.

Item or step 420 refers to categorizing the emergency call, based on the condition, into one of at least two categories.

Method execution may be stopped at item or step 499.

In some preferable embodiments, the method may further comprise preventing or stopping the emergency call in case it is categorized into the non-critical calls category.

The method may also comprise determining a location of the elevator emergency phone 10.

In various embodiments, the location may be determined automatically at a start-up of the elevator emergency phone 10.

The determination of the location may be performed based on a network identification information of a network in which the elevator emergency phone is set to operate or currently operating. Alternatively, the determination of the location may be performed based on a network identification information of a network obtained via a mobile phone of a user situating at the elevator comprising the elevator emergency phone.

On the other hand, the determination of the location is performed based on data from the location sensor of the elevator emergency phone 10 or of the user's mobile phone or other device.

It is also noted herein that while the above describes example embodiments, these should not be viewed in a limiting sense. Rather, there are several variations and modifications, which may be made without departing from the scope of the present disclosure as defined in the appended claims.

The previously presented considerations concerning the various embodiments of the device may be flexibly applied to the embodiments of the method, and vice versa, as being appreciated by a skilled person.

Some advantageous embodiments of the phone and method according to the invention have been described above. The invention is not limited to the embodiments described above, but the inventive idea can be applied in numerous ways within the scope of the claims. The features recited in dependent claims are mutually freely combinable unless otherwise explicitly stated.

1. An elevator emergency phone configured for connecting to a call center, the elevator emergency phone comprising
a user interface element for initiating an emergency call to the call center,
at least one sensor arranged to monitor a condition of elevator car and to generate a sensor signal indicative of the condition,
wherein the elevator emergency phone is configured to:
determine, based on the sensor signal, the condition at an initiation of or during the emergency call, and
categorize the emergency call, based on the condition, into one of at least two categories.

2. The elevator emergency phone of claim 1, wherein the at least two categories include critical calls and non-critical calls.

3. The elevator emergency phone of claim 2, configured to prevent or stop the emergency call in case it is categorized into the non-critical calls category.

4. The elevator emergency phone of claim 1, wherein the at least one sensor comprises a movement sensor for detecting movement of the elevator car.

5. The elevator emergency phone of claim 4, wherein the movement sensor is a speed sensor or an acceleration sensor.

6. The elevator emergency phone of claim 1, wherein the at least one sensor comprises a door sensor for determining a door condition of the elevator car.

7. The elevator emergency phone of claim 6, wherein the door sensor is a vibration sensor for measuring vibrations due to a movement of a door of the elevator car.

8. The elevator emergency phone of claim 6, wherein the door sensor is a magnetic sensor or a magnetic switch for measuring and/or detecting a change in a magnetic field caused by at least one magnet positioned to a door or a door mechanism of the elevator car, the at least one magnet being arranged to move with the door or the door mechanism.

9. The elevator emergency phone of claim 6, wherein the door sensor is an optical sensor, such as a camera, directed towards a door of the elevator car.

10. The elevator emergency phone of claim 1, configured to determine a location of the elevator emergency phone.

11. The elevator emergency phone of claim 10, wherein the determination of the location is performed based on a network identification information of a network in which the elevator emergency phone is set to operate or currently operating.

12. The elevator emergency phone of claim 10, comprising a location sensor, wherein the determination of the location is performed based on data from the location sensor.

13. The elevator emergency phone of claim 11, wherein the location is determined automatically at a start-up of the elevator emergency phone.

14. The elevator emergency phone of claim 10, configured to:
include emergency call center contact details, and
select one of the emergency call center contact details to be used for the emergency call based on the determined location.

15. The elevator emergency phone of claim 14, wherein said one of the emergency call center contact details is selected automatically at a start-up of the elevator emergency phone.

16. The elevator emergency phone of claim 14, wherein the emergency call center contact details are pre-stored in a memory device of the elevator emergency phone.

17. The elevator emergency phone of claim 1, comprising a base material, such as a printed circuit board, and a controlling unit, wherein the at least one sensor and the controlling unit are arranged on the base material and connected to each other via a conductor on the base material.

18. A method for categorizing an emergency call to a call center for elevator systems, the method comprising:
determining, based on a sensor signal of at least one sensor arranged to monitor a condition of elevator car and to generate the sensor signal indicative of the condition, the condition at an initiation of or during an emergency call, and
categorizing the emergency call, based on the condition, into one of at least two categories.

19. The method of claim 18, wherein the at least two categories include critical calls and non-critical calls.

20. The method of claim 19, preventing or stopping the emergency call in case it is categorized into the non-critical calls category.
